(19) United States
(12) Patent Application Publication
(10) Pub. No.: US 2009/0276208 A1
(43) Pub. Date: Nov. 5, 2009

(54) REDUCING SPAM EMAIL THROUGH IDENTIFICATION OF SOURCE

(75) Inventor: William G. Pagan, Durham, NC (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 12/112,668

(22) Filed: Apr. 30, 2008

(51) Int. Cl. G06F 17/27

(52) U.S. Cl. 704/9

(57) ABSTRACT

Embodiments of the present invention address deficiencies of the art in respect to email and provide a novel and non-obvious method and computer program product for detecting undesirable email. In one embodiment of the invention, the method includes receiving an email including text and identifying at least one natural language grammar mistake in the text. The method further includes calculating a country of origin of an author of the text based on the at least one natural language grammar mistake and calculating a first value based on the country of origin of the author of the text. The method further includes correcting the at least one natural language grammar mistake in the text and determining whether the email is undesirable based on the text that was corrected and the first value

### BACKGROUND OF THE INVENTION

1. Field of the Invention

The invention disclosed broadly relates to the field of electronic mail or email and more particularly relates to the field of detecting and eliminating unsolicited email or spam.

2. Description of the Related Art

The emergence of electronic mail, or email, has changed the face of modern communication. Today, millions of people every day use email to communicate instantaneously across the world and over international and cultural boundaries. It is estimated that the United States alone boasts over 200 million email users out of a total population of about 300 million. The use of email, however, has not come without its drawbacks.

Almost as soon as email technology emerged, so did unsolicited email, also known as spam. Unsolicited email typically comprises an email message that advertises or attempts to sell items to recipients who have not asked to receive the email. Most spam is commercial advertising for products, pornographic web sites, get-rich-quick schemes, or quasi-legal services. Spam costs the sender very little to send—most of the costs are paid for by the recipient or the carriers rather than by the sender. Reminiscent of excessive mass solicitations via postal services, facsimile transmissions, and telephone calls, an email recipient may receive hundreds of unsolicited e-mails over a short period of time. On average, Americans receive 200 unsolicited messages in their personal or work email accounts each week. This results in a net loss of time, as workers must open and delete spam emails. Similar to the task of handling “junk” postal mail and faxes, an email recipient must laboriously sift through his or her incoming mail simply to sort out the unsolicited spam email from legitimate emails. As such, unsolicited email is no longer a mere annoyance—its elimination is one of the biggest challenges facing businesses and their information technology infrastructure. Technology, education and legislation have all taken roles in the fight against spam.

Presently, a variety of methods exist for detecting, labeling and removing spam. Vendors of electronic mail servers, as well as many third-party vendors, offer spam-blocking software to detect, label and sometimes automatically remove spam. One known method for eliminating spam employs the use of grammars. In computer science, a grammar is a precise description of a language, such as a set of strings over some alphabet. A grammar describes which of the possible sequences of basic items in a language actually constitute valid words or sentences in that language, but it does not describe their semantics (i.e. what they mean). This approach, however, only uses one aspect of an email to determine whether it is spam, and therefore is prone to error. Various other aspects of an email that indicate whether it is spam, such as its country of origin or the country of origin or the author, are not considered by this approach.

Therefore, a need exists to overcome the problems with the prior art as discussed above, and particularly for a way to simplify the task of detecting and eliminating spam email.

### BRIEF SUMMARY OF THE INVENTION

Embodiments of the present invention address deficiencies of the art in respect to email and provide a novel and non-obvious method and computer program product for detecting undesirable email. In one embodiment of the invention, the method includes receiving an email including text and identifying at least one natural language grammar mistake in the text. The method further includes calculating a country of origin of an author of the text based on the at least one natural language grammar mistake and calculating a first value based on the country of origin of the author of the text. The method further includes correcting the at least one natural language grammar mistake in the text and determining whether the email is undesirable based on the text that was corrected and the first value.

In another embodiment of the invention, a computer program product comprising a computer usable medium embodying computer usable program code for detecting undesirable email is provided. The computer program product includes computer usable program code for receiving an email including text and identifying at least one natural language grammar mistake in the text. The computer program product further includes computer usable program code for calculating a country of origin of an author of the text based on the at least one natural language grammar mistake and calculating a first value based on the country of origin of the author of the text. The computer program product further includes computer usable program code for correcting the at least one natural language grammar mistake in the text and determining whether the email is undesirable based on the text that was corrected and the first value.

In yet another embodiment of the invention, the method for detecting undesirable email includes receiving an email including text and identifying at least one natural language grammar mistake in the text. The method further includes comparing the at least one natural language mistake to a first list that associates natural language mistakes to a country of origin and calculating a country of origin of an author of the text based on the first list. The method further includes comparing the country of origin of the author of the text to a second list that associates countries of origin with a value and calculating a first value based on the second list. The method further includes correcting the at least one natural language grammar mistake in the text and determining whether the email is undesirable based on the text that was corrected and the first value.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is block diagram showing a high-level network architecture according to an embodiment of the present invention; and

FIG. 2 is a flowchart showing the control flow of one embodiment of the present invention.

### DETAILED DESCRIPTION OF THE INVENTION

Embodiments of the present invention provide a novel and non-obvious method and computer program product for detecting spam email. The method includes receiving an email including text and identifying at least one natural language grammar mistake in the text. Next, a country of origin of an author of the email is calculated based on the types of grammar mistakes that were identified, since grammar mistakes of certain types correspond to individuals from certain countries. Next, a first value is calculated based on the country of origin of the author of the text, wherein the first value indicates the likelihood that the mail is spam email, since certain countries are more likely to produce spam email than others. The method further includes correcting the at least one natural language grammar mistake in the text and executing conventional email detection on the corrected text. A second value is calculated based on the conventional email detection, wherein the second value indicates the likelihood that the mail is spam email. Lastly, the first and second values are combined to determine whether the email is spam email.

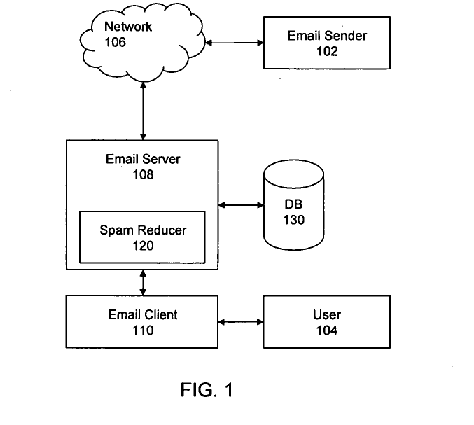

FIG. 1 is block diagram showing a high-level network architecture according to an embodiment of the present invention. FIG. 1 shows an email server 108 connected to a network 106. The email server 108 provides email services to a local area network (LAN) and is described in greater detail below. The email server 108 comprises any commercially available email server system that can be programmed to offer the functions of the present invention. FIG. 1 further shows an email client 110, comprising a client application running on a client computer, operated by a user 104. The email client 110 offers an email application to the user 104 for handling and processing email. The user 104 interacts with the email client 110 to read and otherwise manage email functions.

FIG. 1 further includes a spam reducer 120 for processing email messages and identifying and reducing unsolicited, or spam, email, in accordance with one embodiment of the present invention. The spam reducer 120 can be implemented as hardware, software or any combination of the two. Note that the spam reducer 120 can be located in either the email server 108 or the email client 110 or there-between. Alternatively, the spam reducer 120 can be located in a distributed fashion in both the email server 108 and the email client 110. In this embodiment, the spam reducer 120 operates in a distributed computing paradigm.

FIG. 1 further shows an email sender 102 connected to the network 106. The email sender 102 can be an individual, a corporation, or any other entity that has the capability to send an email message over a network such as network 106. The path of an email in FIG. 1 begins, for example, at email sender 102. The email then travels through the network 106 and is received by email server 108, where it is optionally processed according to the present invention by the spam reducer 120. Next, the processed email is sent to the recipient, email client 110, where it is optionally processed by the spam reducer 120 and eventually viewed by the user 104. This process is described in greater detail with reference to a flowchart below.

Also shown in FIG. 1 is a database 130 for storing information used during the spam email detection process, such as common human-language grammar mistakes, a list of identities of countries, a list of identities of countries from which spam often originates, weights associated with countries from which spam often originates and/or similar information. The database 130 may be any commercially available database such as the DB2 database available from International Business Machines of Armonk, N.Y.

In an embodiment of the present invention, the computer systems of the email client 110 and the email server 108 are one or more Personal Computers (PCs) (e.g., IBM or compatible PC workstations running the Microsoft Windows operating system or equivalent), Personal Digital Assistants (PDAs), hand held computers, palm top computers, smart phones, game consoles or any other information processing devices. In another embodiment, the computer systems of the email client 110 and the email server 108 are a server system (e.g., IBM RS/6000 workstations and servers running the AIX operating system or SUN Ultra workstations running the SunOS operating system). The computer systems of the email client 110 and the email server 108 are described in greater detail below.

In another embodiment of the present invention, the network 106 is a circuit switched network, such as the Public Service Telephone Network (PSTN). In yet another embodiment, the network 106 is a packet switched network. The packet switched network is a wide area network (WAN), such as the global Internet, a private WAN, a telecommunications network or any combination of the above-mentioned networks. In yet another embodiment, the network 106 is a wired network, a wireless network, a broadcast network or a point-to-point network.

It should be noted that although email server 108 and email client 110 are shown as separate entities in FIG. 1, the functions of both entities may be integrated into a single entity. It should also be noted that although FIG. 1 shows one email client 110 and one email sender 102, the present invention can be implemented with any number of email clients and any number

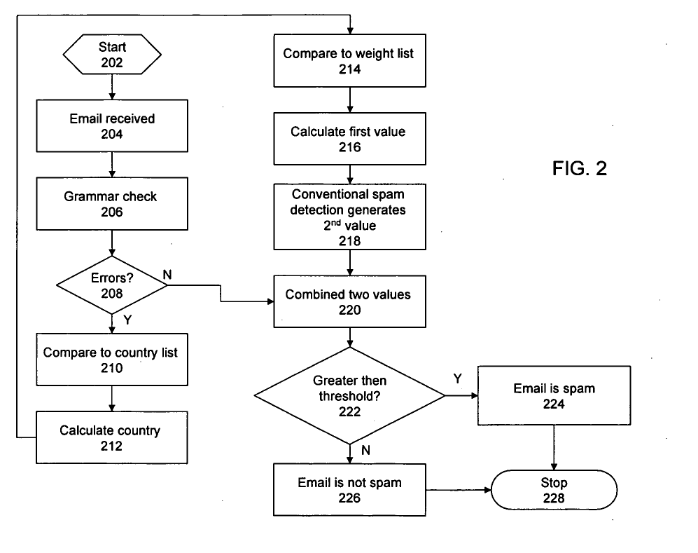

FIG. 2 is a flowchart showing the control flow of one embodiment of the present invention. FIG. 2 summarizes a process on a receiving server of detecting spam email. The control flow of FIG. 2 begins with step 202 and flows directly to step 204. In step 204, an incoming email from email sender 102 is received by the receiving email server 108.

Next, the spam reducer 120 executes and begins the process of determining whether email received is a spam email. This process beings in step 206 when the spam reducer 120 conducts a natural language (such as the English language) grammar check of the text of the email. In this step, a grammar checker determines whether any natural language grammar mistakes appear in the text of the email. A grammar checker is a software program designed to verify written natural language text for grammatical correctness. The grammar checker may utilize data that is stored in database. If it is determined in step 208 that no grammar mistakes are identified, then control flows to step 220. Otherwise, control flows to step 210.

Subsequently, in step 210, the grammar mistakes detected in step 206 are compared to a list of grammar mistakes corresponding to countries. The list may be stored in database 130. The list may comprise a two-column table wherein for each row, a grammar mistake is located in the first row and an identity of a country is located in the second row. Using this list, in step 212, the spam reducer 120 makes a determination of the country of origin of the author of the text in the email. If more than one grammar mistake is identified and more than one country of origin is identified in the list, then a mode (or most frequent value) of the countries of origin is taken. A sample portion of the list of steps 210-212 is provided below:

| Grammar Mistake | Country of Origin |
|---|---|
| “I would of” | Nigeria |
| “between he” | Russia |
| “its not” | Puerto Rico |

Next in step 214, the country of origin calculated in step 212 is compared to a list of countries corresponding to values. The list may be stored in database 130. The list may comprise a two-column table wherein for each row, a country is located in the first row and a value is located in the second row. Using this list, in step 216, the spam reducer 120 makes a determination of a first value to assign to the email. A first value may be a numerical value, such as a value between one and zero. A sample portion of the list of steps 214-216 is provided below:

| Country of Origin | Value |
|---|---|
| Nigeria | 0.9 |
| Russia | 0.9 |
| Puerto Rico | 0.5 |

In step 218, conventional spam detection is executed. Conventional spam detection includes a variety of mechanisms that can be utilized to determine whether an incoming email is either spam email or non-spam email. This includes taken various factors into account, such as the source of the email, the content of text or images in the email, the number of people to whom the email is addressed, the presence of certain keywords or key phrases in the content of the email, input from human users and the like. The result of the execution of step 218 is the generation of a second value that indicates the probability that the email is spam email. The second value may be a numerical value, such as a value between one and zero.

In step 220, the first and second values are combined into a third value, such as calculating a mean or a median of the two values. In step 222, it is determined whether the third value is greater than a predetermined threshold value. If the third value is greater than a predetermined threshold value, then control flows to step 224, wherein the email is determined to be spam email. Subsequently, the email can then be filed, viewed by the user 104, deleted, or processed automatically. If the third value is not greater than a predetermined threshold value, then control flows to step 226, wherein the email is determined not to be spam email. Subsequently, the email can automatically proceed to regular delivery to the intended user 104. In step 228, the control flow of FIG. 2 ceases.

Embodiments of the present invention can take the form of an entirely hardware embodiment, an entirely software embodiment or an embodiment containing both hardware and software elements. In a preferred embodiment, the present invention is implemented in software, which includes but is not limited to firmware, resident software, microcode, and the like. Furthermore, the present invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

I claim:

1. A method for detecting undesirable email, comprising:
receiving an email including text;
identifying at least one natural language grammar mistake in the text;
calculating a country of origin of an author of the text based on the at least one natural language grammar mistake;
calculating a first value based on the country of origin of the author of the text;
correcting the at least one natural language grammar mistake in the text; and
determining whether the email is undesirable based on the text that was corrected and the first value.

2. The method of claim 1, wherein the step of identifying further comprises:
identifying at least one English language grammar mistake in the text.

3. The method of claim 1, wherein the first step of calculating further comprises:
comparing the at least one natural language grammar mistake to a first list of natural language mistake entries, wherein each entry is associated with a country of origin;
finding a match between the at least one natural language grammar mistake and at least one entry in the first list; and
associating the country of origin of the at least one entry with the author of the text.

4. The method of claim 2, wherein the second step of calculating further comprises:
comparing the country of origin to a second list of country of origin entries, wherein each entry is associated with a value;
finding a match between the country of origin and at least one entry in the second list; and
calculating a first value based on the value associated with the at least one entry.

5. The method of claim 4, wherein the step of calculating a first value further comprises:
calculating a first value equal to a mode of values associated with each of the at least one entries.

6. The method of claim 4, wherein the step of determining further comprises:
calculating a second value based on a likelihood that the text that was corrected indicates undesirable email;
calculating a third value based on the first value and the second value; and
determining that the email is undesirable if the third value is greater than a predetermined value.

7. A computer program product comprising a computer usable medium embodying computer usable program code for detecting undesirable email, comprising:
computer usable program code for receiving an email including text;
identifying at least one natural language grammar mistake in the text;
calculating a country of origin of an author of the text based on the at least one natural language grammar mistake;
calculating a first value based on the country of origin of the author of the text;
correcting the at least one natural language grammar mistake in the text; and
determining whether the email is undesirable based on the text that was corrected and the first value.

8. The computer program product of claim 7, wherein the computer usable program code for identifying further comprises:
computer usable program code for identifying at least one English language grammar mistake in the text.

9. The computer program product of claim 7, wherein the first computer usable program code for calculating further comprises:
computer usable program code for comparing the at least one natural language grammar mistake to a first list of natural language mistake entries, wherein each entry is associated with a country of origin;
computer usable program code for finding a match between the at least one natural language grammar mistake and at least one entry in the first list; and
computer usable program code for associating the country of origin of the at least one entry with the author of the text.

10. The computer program product of claim 8, wherein the second computer usable program code for calculating further comprises:
computer usable program code for comparing the country of origin to a second list of country of origin entries, wherein each entry is associated with a value;
computer usable program code for finding a match between the country of origin and at least one entry in the second list; and
computer usable program code for calculating a first value based on the value associated with the at least one entry.

11. The computer program product of claim 10, wherein the computer usable program code for calculating a first value further comprises:
computer usable program code for calculating a first value equal to a mode of values associated with each of the at least one entries.

12. The computer program product of claim 10, wherein the computer usable program code for determining further comprises:
computer usable program code for calculating a second value based on a likelihood that the text that was corrected corresponds to undesirable email;
computer usable program code for calculating a third value based on the first value and the second value; and
computer usable program code for determining that the email is undesirable if the third value is greater than a predetermined value.

13. A method for detecting undesirable email, comprising:
receiving an email including text;
detecting at least one natural language grammar mistake in the text;
comparing the at least one natural language mistake to a first list that associates natural language mistakes to a country of origin;
calculating a country of origin of an author of the text based on the first list;
comparing the country of origin of the author of the text to a second list that associates countries of origin with a value;
calculating a first value based on the second list;
correcting the at least one natural language grammar mistake in the text; and
determining whether the email is undesirable based on the text that was corrected and the first value.

14. The method of claim 13, wherein the step of detecting further comprises:
detecting at least one English language grammar mistake in the text.

15. The method of claim 14, wherein the second step of comparing further comprises:
comparing the country of origin of the author of the text to a second list that associates countries of origin with a value, and finding a plurality of matching entries.

16. The method of claim 15, wherein the step of calculating a first value further comprises:
calculating a first value by calculating a mode of values of the plurality of matching entries.

17. The method of claim 14, wherein the step of determining further comprises:
calculating a second value based on a likelihood that the text that was corrected corresponds to undesirable email;
calculating a third value based on the first value and the second value; and
determining that the email is undesirable if the third value is greater than a predetermined value.
